(19) United States
(12) Patent Application Publication
(10) Pub. No.: US 2010/0305976 A1
(43) Pub. Date: Dec. 2, 2010

(54) SYSTEM AND METHOD FOR ADMINISTERING LAST SURVIVOR LIFE INSURANCE POLICY

(75) Inventors: Paul M. Fischer, Avon, CT (US); Shawn M. Denman, Torrington, CT (US); Lisa Proch, North Haven, CT (US)

Correspondence Address: Howard IP Law Group, P.O. Box 226, Fort Washington, PA, 19034, US

(73) Assignee: HARTFORD FIRE INSURANCE COMPANY, Hartford, CT (US)

(21) Appl. No.: 12/474,308

(22) Filed: May 29, 2009

(51) Int. Cl. G06Q 40/00

(52) U.S. Cl. 705/4

(57) ABSTRACT

A computer system for administering a last survivor life insurance policy paying a death benefit on the death of the last survivor of insureds, includes a processor; and a memory storage device in communication with the processor. The processor is adapted to: determine at least one variable of a feature related to the policy based on a mortality charge based on, for each future year of the policy, a sum of the statistical likelihoods of the deaths of each of the insureds determined as of the policy issue date; store data indicative of the determined variable; output a signal having data indicative of the determined variable; access data indicative of whether any of the insureds is deceased; if all of the insureds are deceased, access data indicative of the death benefit amount under the policy and an identity of a beneficiary, the identity including at least a name and address; and output a signal having data indicative of the amount of the death benefit under policy and the identity of the beneficiary.

### FIELD OF INVENTION

The present invention relates to computer systems, and particularly to computer systems for calculating features of financial products.

### BACKGROUND

In life insurance policies, a monetary benefit is conventionally paid upon the death of an insured to a beneficiary. In last survivor life insurance policies, the benefit is payable upon the death of the last to survive of two or more insureds. Last survivor life insurance policies are employed, for example, by couples desiring to leave a benefit to children to offset estate tax obligations, as an inheritance and for assistance with expenses associated with the final expenses of the couple. The premium calculation for last survivor policies is conventionally performed prior to issue of the policy based on then-applicable actuarial information regarding both of the couple. An issuer of the policy may charge a single premium at the time of issue, based on the actuarial information at the time of issue. An issuer of the policy may charge an ongoing premium based on the actuarial information at the time of issue. The premium is not affected by the health status of the insureds, or by the death of one of the insureds. A known prior art method of determining a premium amount on a last survivor policy that is not affected by the death of one of the insureds is referred to in the field as Frasierization.

An owner of a last survivor life insurance policy may find a death benefit payable on the death of each of the insureds to be desirable. In the prior art, this may be accomplished by purchasing separate term life policies on each of the insureds.

An insured who is terminally ill may have significant medical and care expenses in the last months of life. In addition to medical expenses, persons may lose physical and cognitive abilities and require services such as home health aides, assisted living facilities and nursing care. The intended purpose of the individual life death benefit payable under a life insurance policy, such as to provide replacement of the insured's wages to support a child through the child's education, may no longer be relevant for an insured who is terminally ill. For example, the child may have completed his or her education and may now be supported by the child's own wages. In order to provide funds for expenses associated with terminal and chronic illness, life insurance policies may include riders that enable an insured to accelerate benefit payments, so that benefit payments may be made to the insured during the insured's life, rather than to the beneficiary after the death of the insured. These riders are referred to as living benefit riders or accelerated benefit riders. The acceleration of payments may be conditioned on an independent certification of the state of the insured's health.

### SUMMARY

In one embodiment, a computer system for administering a last survivor life insurance policy paying a death benefit on the last to die of a first insured and a second insured includes a processor and a memory storage device in communication with the processor. The processor is adapted to store data indicative of at least the insureds and the death benefit under the last survivor life insurance policy; store data indicative of joint term life riders associated with the policy and providing death benefits upon the death of either of the insureds; store data indicative of living benefit riders associated with the joint term life riders and permitting acceleration of the death benefits; store data indicative of a premium for the joint term life riders, the premium being level from issue of the policy until the death of the last survivor of the insureds; access data indicative of whether either of the insureds has a terminally ill status; if one of the insureds has a terminally ill status, prompt a user for a periodic payment amount under the living benefit rider; receive from the user the periodic payment amount; output a signal having data indicative of instructions to pay the one of the insureds benefits in accordance with the received periodic payment amount; access data indicative of whether either or both of the insureds is deceased; when one of the insureds is deceased, access data indicative of a death benefit amount payable under the joint term life riders; output a signal having data indicative of the death benefit amount; when both of the insureds are deceased, access data indicative of the death benefit amount under the last survivor policy and an identity of a beneficiary, the identity including at least a name and address; and output a signal having data indicative of the amount of the death benefit under the last survivor policy and the identity of the beneficiary.

In an embodiment, a computer system for administering a last survivor life insurance policy paying a death benefit on the death of the last survivor of insureds includes a processor; and a memory storage device in communication with the processor. The processor is adapted to: determine at least one variable of a feature related to the policy based on a mortality charge based on, for each future year of the policy, a sum of the statistical likelihoods of the deaths of each of the insureds determined as of the policy issue date; store data indicative of the determined variable; output a signal having data indicative of the determined variable; access data indicative of whether any of the insureds is deceased; responsive to accessing data indicative that all of the insureds are deceased, access data indicative of the death benefit amount under the policy and an identity of a beneficiary, the identity including at least a name and address; and output a signal having data indicative of the amount of the death benefit under policy and the identity of the beneficiary.

In an embodiment, a computer-implemented method for administering a last survivor life insurance policy paying a death benefit on the death of the last survivor of a plurality of insureds, includes: determining by the processor at least one variable of a feature related to the policy based on a mortality charge based on, for each future year of the policy, a sum of the statistical likelihoods of the deaths of each of the insureds determined as of the policy issue date; storing by the processor in a memory device data indicative of the determined variable; outputting by the processor a signal having data indicative of the determined variable; accessing by the processor data indicative of whether the insureds are deceased; responsive to accessing data indicative that all of the insureds are deceased, accessing by the processor data indicative of the death benefit amount under the policy and an identity of a beneficiary, the identity including at least a name and address; and outputting by the processor a signal having data indicative of the amount of the death benefit under the policy and the identity of the beneficiary.

In an embodiment, a computer-readable medium having a plurality of instructions thereon for use in administration of last survivor life insurance policies having a death benefit payable upon the death of the last to die of at least two insureds, which instructions, when executed by a processor, cause the processor to: determine at least one variable of a feature related to the policy based on a mortality charge based on, for each future year of the policy, a sum of the statistical likelihoods of the deaths of each of the insureds determined as of the policy issue date; store data indicative of the determined variable; output a signal having data indicative of the determined variable; access data indicative of whether any of the insureds is deceased; responsive to accessing data indicative that all of the insureds are deceased, access data indicative of the death benefit amount under the policy and an identity of a beneficiary, the identity including at least a name and address; and output a signal having data indicative of the amount of the death benefit under policy and the identity of the beneficiary.

### BRIEF DESCRIPTION OF THE FIGURES

FIG. 1 is a schematic diagram of an exemplary computer system for implementation of a method and system of the invention.

FIG. 2 is a schematic diagram of an exemplary network for implementation of a method and system of the invention.

FIG. 3 is a schematic diagram showing the computer system of FIG. 1 and payment systems.

FIG. 4 is a process flow diagram illustrating a method for administering a last survivor life insurance policy implemented by the computer system of FIG. 1.

FIG. 5 is a schematic diagram showing features of a last survivor life insurance policy in an embodiment.

FIGS. 6A, 6B and 6C constitute a process flow diagram illustrating an embodiment of a method for administration of a last survivor life insurance policy having a joint term life rider with living benefit endorsements.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for administration of insurance policies such as last survivor life insurance policies, joint term life insurance policies, and life insurance policy riders that provide for accelerated payments to an insured during the insured's lifetime under certain conditions. By way of example, life insurance policy riders that provide for accelerated payments to an insured during the insured's lifetime are disclosed in commonly-assigned U.S. Patent Publication No. 20080147447, which publication is incorporated by reference herein in its entirety. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

A challenge recognized by the inventors in connection with last survivor life insurance policies is that of proper determination of various data items that relate to last survivor life insurance policies. For example, it may be desired to obtain death benefits upon the death of each of the insureds, supplemental to the last survivor death benefit of the last survivor life insurance policy. Separate term policies for each of the insureds may be obtained. As the first to die is not known, premiums must be paid on both term policies until the death of the first to die. Only after the death of the first to die will the owner be able to predict the future annual cost of the term life coverage.

A further challenge recognized by the inventors is that of providing life insurance policies with an accelerated benefit payable to an owner, who may be the insured, prior to death in the event of a terminal illness or other condition, in connection with a last survivor life insurance policy. A last survivor life policy provides a death benefit upon the death of the last-to-die of two or more insureds. As the identity of the insured that will die last is not known when the policy is issued, acceleration of the death benefit or a portion of the death benefit of a last survivor life insurance policy when one of the insureds becomes terminally ill or suffers a chronic illness is not feasible.

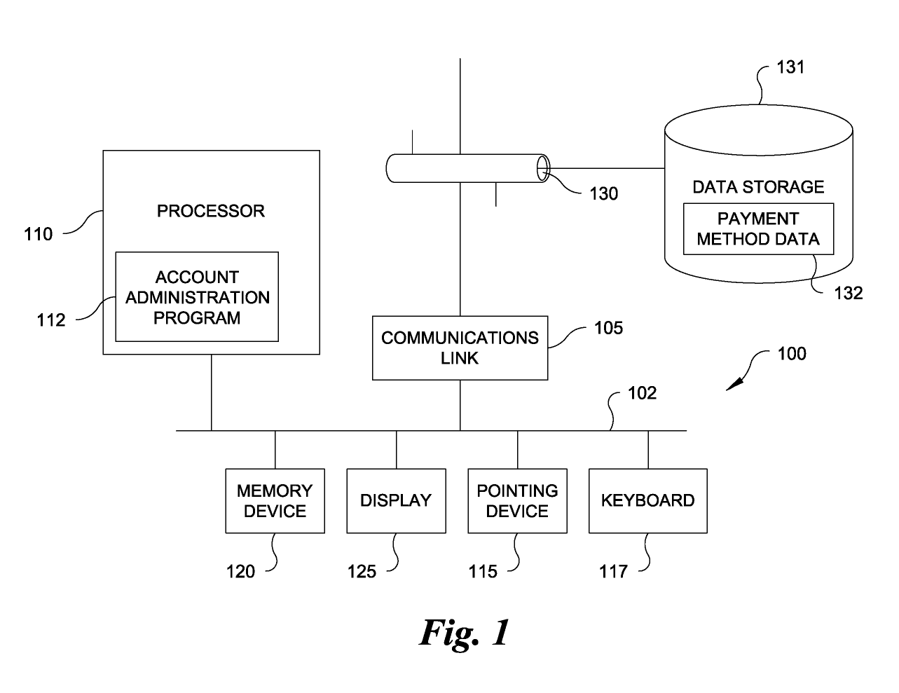

Referring to FIG. 1, an exemplary computer system 100 for use in an implementation of the invention will now be described. In computer system 100, processor 110 executes instructions contained in programs such as account administration program 112. Programs may be stored on suitable media, such as optical or magnetic disks, fixed disks with magnetic storage (hard drives), tapes accessed by tape drives, and other storage media. Processor 110 communicates, such as through bus 102 and/or other data channels, with communications port 105 and memory device 120, receives data from user inputs 115, and provides data to outputs 125. Memory device 120 is configured to exchange data with processor 110, and may store programs containing processor-executable instructions, and values of variables for use by such programs. User input may be provided at inputs 115, which may include keyboards, pointing devices such as mice, and touch screens. In an embodiment, inputs 115 may include user interfaces, including workstations having keyboards, touch screens, pointing devices such as mice, or other user input devices, connected via networked communications to processor 110. Outputs 125 may include displays and printers. Communications port 105 may communicate with remote sources of information, and with systems for implementing instructions output by processor 110, via LAN 130. LAN 130 is merely exemplary, and communication may be by one or more of suitable communication methods, including over wired or wireless local area networks and wide area networks, and over communications between networks, including over the Internet. Any suitable data and communication protocols may be employed. Data storage 131, which may include a wide variety of data acquired and processed in accordance with embodiments, is accessed via LAN 130. Data storage 131 may include payment method data 132, by way of example.

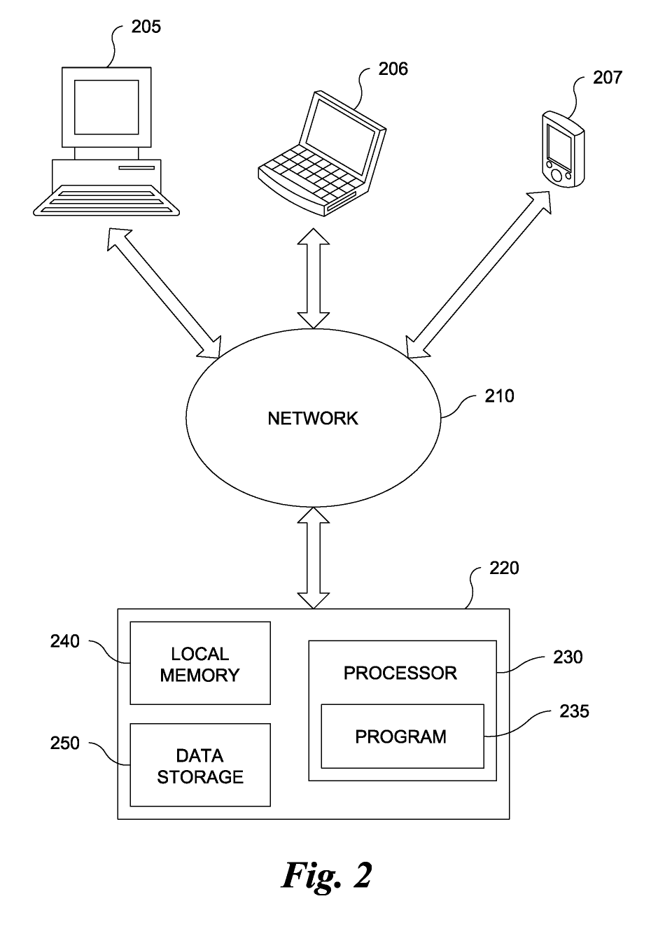

Referring now to FIG. 2, a schematic diagram of a client server arrangement for implementation of a method and system in accordance with an embodiment of the invention is presented. In the arrangement of FIG. 2, client devices 205, 206, 207 may be connected via network 210 to server 220. In an implementation, client devices 205, 206, 207 may be personal computers running an operating system such as Windows XP, Windows Vista, or Apple Tiger, thin client devices, portable devices such as personal digital assistants (running the Palm OS, by way of example), cell phones, or other devices. Client devices may be operated variously by individual prospective insureds, insurance brokers or other financial advisors, or by personnel of an insurance service provider. Network 210 may be or include the Internet, a corporate intranet, wireless and wired communications channels, and other network features. Server 220 may include processor 230 having local memory 240 and data storage 250. Illustration program 235 runs on processor 230. Program 235 may initiate sessions with one more of client devices 205, 206, 207. Program 235 may cause server 220 to serve for display on client devices 205, 206, 207, prompts to the user for information regarding desired benefit amounts for the last survivor policy, desired benefit amounts for the joint term rider, ages of the persons proposed to be insured, and health data concerning the persons proposed to be insured.

Program 235 may include instructions causing processor 230 to determine features, such as premiums, of a last survivor life insurance policy with joint term riders and accelerated benefit riders, and to format and serve to client devices 205, 206, 207 illustrations of such insurance policies. Program 235 may include instructions causing processor 230 to display prompts to permit a user to change input data, such as desired benefit amounts, in association with an illustration, such as on the same screen as an illustration, via a link on the screen displaying the illustration to one or more pages permitting a user to change the data. In response to receipt of the changed data, program 235 may cause the processor 230 to determine and to serve to the appropriate one of the client devices 205, 206, 207 an updated illustration.

Program 235 may also provide a web front end, and be linked to back end computer systems for implementing administration of insurance policies including last survivor policies with joint term riders having accelerated benefit riders, as well as to back end systems for other insurance company-administered products and services. Program 235 may, by way of example, provide a user with options to update contact information and payment information, such as bank account and routing number for electronic payments, and be configured to receive a signal from user device 205, 206, 207 inputting such information, and to communicate such information to a back end system, such as system 100, so as to permit user selection of payment information. Program 235 may be configured to provide a user with options to select a monthly payment amount of accelerated benefits, or to select a lump sum payment, and to communicate such information to a back end system, such as system 100. Program 235 may be, by way of example only, a Java-based program.

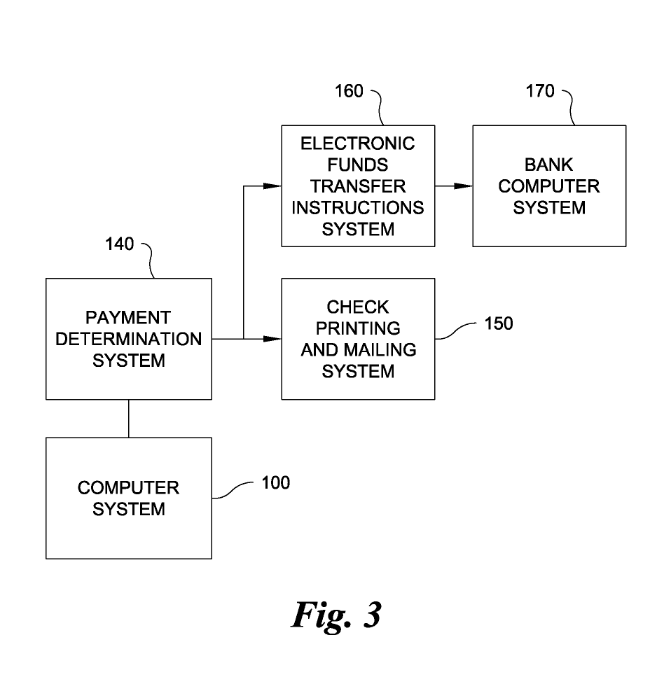

Referring now to FIG. 3, a schematic diagram showing a processor for administration of insurance policies and a payment system are shown. System 100 may communicate with payment determination system 140. Payment determination system 140 may include one or more computer systems, including processors, memory devices, user inputs, outputs, software executed by the processors, and other conventional components. Payment determination system 140 may be adapted to receive an output signal from computer system 100, such as via LAN 130 of FIG. 1, which output signal includes data indicative of payment information, such as amounts payable to an insured under an accelerated benefit rider, or to a beneficiary under a joint term rider, a date payable, and payment methods. Payment determination system 140 may further be adapted to determine a payor account and a payment method. The payor account may be an account with a selected bank; by way of example, payment determination system 140 may include a look-up table mapping beneficiary information, such as geographic information, to a particular bank and account. Payment determination system 140 may also include stored in memory and accessible by a processor information indicating whether a particular insured or beneficiary is to be paid by paper check, by electronic funds transfer, or by another payment method. A processor of payment determination system 140 may cause to be stored in memory of the payment determination system the determined payor account information and the determined payment method. The processor of payment determination system 140 may cause a digital signal to be output indicative of the stored payor account information, the stored payment method, amount information and payee information. Depending on the payment method information, payment determination system 140 may direct a signal to one of a number of potential recipients. The potential recipients may include payment fulfillment systems, such as check printing and mailing system 150 and electronic funds transfer instructions system 160. The payment fulfillment systems may be for receiving the digital signal from the payment determination system 140 and for fulfillment of payment in accordance with the information conveyed by the digital signal from the processor of the payment determination system 140.

In an embodiment, the payment method may be by check; given that payment method, the output digital signal from payment determination system 140 may be received by check printing and mailing system 150. Check printing and mailing system 150 may include one or more computer systems, including processors, memory devices, user inputs, outputs, software executed by the processors, and other conventional components. The outputs include in particular one or more printers, and may include other devices useful in printing and mailing paper checks, such as devices for feeding paper, separating printed checks, inserting printed checks into envelopes, sealing envelopes, and applying postage to envelopes as appropriate. Check printing and mailing system 150 may print a check drawn on a payor account in an amount and to a payee as determined by the information conveyed by the digital signal from the processor of payment determination system 140. The printed check is then mailed to the payee. The payee deposits the check in the payee's bank account, causing funds to be credited to the payee's bank account, and causing the funds to be withdrawn from the designated payor bank account from which the payment is made.

In an embodiment, the output digital signal from payment determination system 140 may be received by electronic funds transfer instructions system 160. For example, this may be the case if the payment method is by electronic funds transfer to the payee's designated account. System 160 may be for generating electronic funds transfer instructions for providing of an instruction to a bank determined by the payor account information to provide an electronic funds transfer from the payor account to a payee account in an amount determined by the information conveyed by the digital signal from the processor of the payment determination system. Electronic funds transfer instructions system 160 may include one or more computer systems, including processors, memory devices, user inputs, outputs, software executed by the processors, and other conventional components. Electronic funds transfer instructions system 160 includes a processor adapted to provide an output signal indicative of an instruction to a bank determined by the payor account information to provide an electronic funds transfer from the payor account to a payee account in an amount as previously determined, such as by processor 110. The amount is the amount determined by the information conveyed by the digital signal from payment determination system 140.

The output signal from electronic funds transfer instructions system 160 may be provided to a bank computer system 170, which carries out an electronic funds transfer, debiting the designated account, and resulting in a credit to a designated payee account.

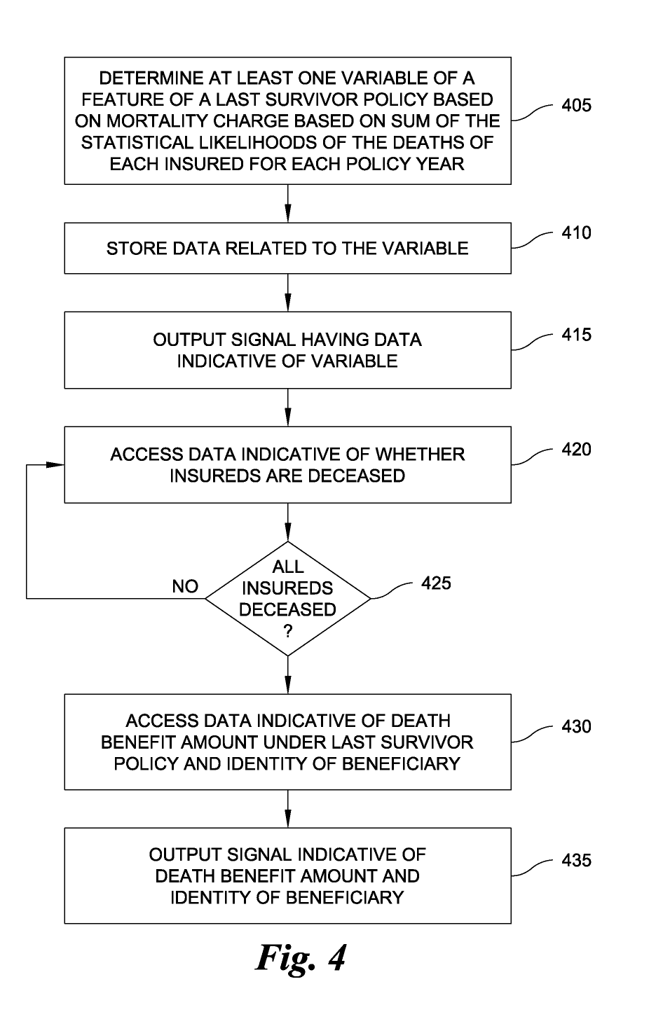

Referring now to FIG. 4, a high-level process flow of a computer-implemented process for administering a last survivor life insurance policy. The last survivor life insurance policy pays a death benefit on the death of the last survivor of multiple insureds. The process flow may commence with determining 405 by the processor at least one variable of a feature related to the policy based on a mortality charge based on, for each future year of the policy, a sum of the statistical likelihoods of the deaths of each of the insureds determined as of the policy issue date. Examples of features related to the policy may be a joint term rider that provides a death benefit upon the death of each insured. Non-limiting examples include reserves associated with the last survivor life insurance policy, demonstration of compliance with nonforfeiture requirements; determination of shadow fund values; determination of premium limitations associated with life insurance status for certain regulatory purposes; and determination of fair market values of life insurance policies for various purposes such as deemed compensation in split-dollar funded life insurance programs. The mortality charge may be determined by the processor based on data pertaining to the insureds, including age, gender, and underwriting rating information, and statistical likelihoods of deaths of the insureds based on such data as applied in actuarial tables. Based on the actuarial data, for each year of the policy, there are statistical likelihoods that all of the insureds will be alive, that all of the insureds will be dead, and that each intermediate number of insureds will be alive. Based on those statistical likelihoods, and an appropriate discount rate, a suitable mortality charge may be determined.

Based on the mortality charge and other formulas and data well known to those of skill in the art, a variable, such as a premium for the joint term rider, may be determined. The premium may be a single premium payable at the time of issue of the last survivor life insurance policy. The premium may be a level premium to be paid periodically, such as annually, quarterly or monthly, throughout the term of the last survivor life insurance policy. If the premium for the joint term life rider is to be paid periodically, the premium for the joint term rider is not changed as long as at least one of the insureds is living. For example, if the last survivor life insurance policy covers two insureds, the death of one of the insureds does not change the premium.

The process flow may continue with storing 410 by the processor in a memory device data indicative of the determined variable. The stored data may be an amount of a single premium, or an amount and schedule for required payments of premiums.

The processor may output 415 a signal having data indicative of the determined variable. In an embodiment in which the determined variable is a premium amount, the output signal may be provided to a computer system that operates a system for generation of bills.

During the term of the last survivor policy, the processor may access 420 from a suitable data storage device data indicative of whether the insureds are deceased. If the processor determines, based on the accessed data, that all of the insureds are deceased 425, the processor may access 430 data indicative of the death benefit amount under the policy. The processor may access data indicative of other information useful in connection with paying the death benefit, such as an identity of a beneficiary, the identity including at least a name and address of the beneficiary. The name and address of a beneficiary will be understood to include the name and address of an agent for or other representative of the beneficiary.

The processor may output 435 a signal having data indicative of the amount of the death benefit under the policy and the identity of the beneficiary. The signal may be provided to a payment determination system 140 of FIG. 3, for example.

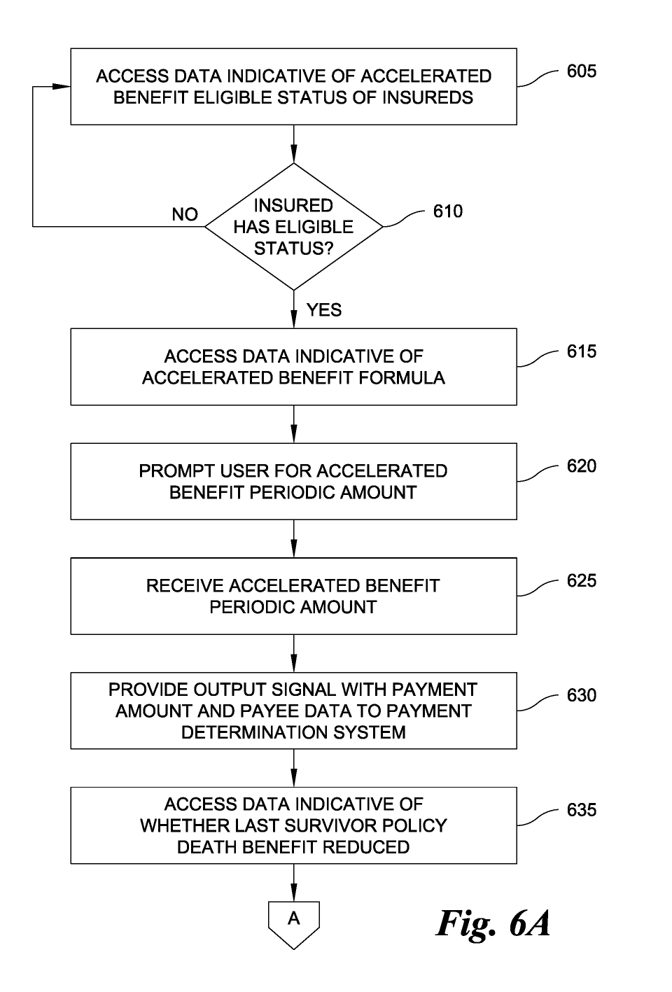

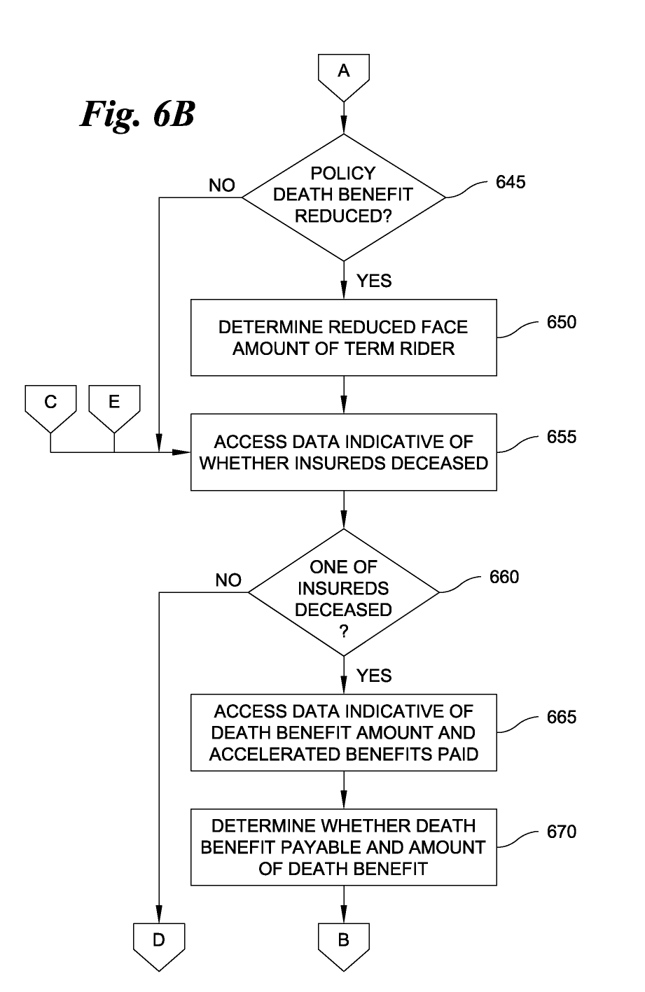

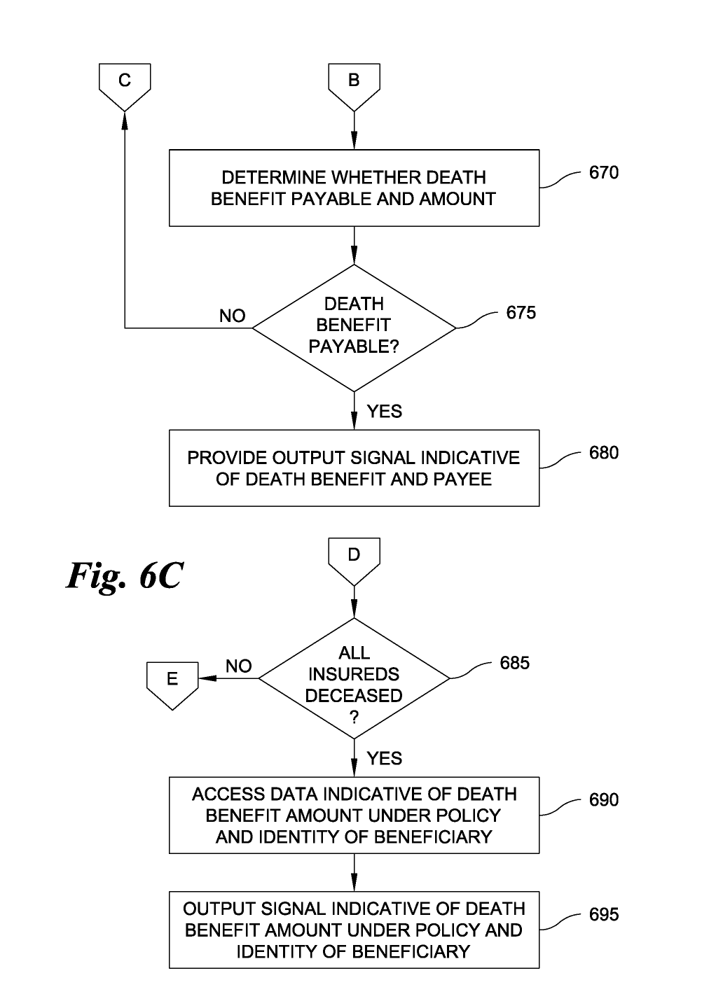

Referring now to FIG. 6, in an embodiment, a last survivor life insurance policy has two insureds, a joint term rider providing a death benefit upon the deaths of the insureds, and an acceleration rider for each insured on the joint term rider. A processor accesses 605 from a memory storage device data indicative of whether either of the joint insureds has an accelerated benefit eligible status under an acceleration rider of a joint term rider of the policy. In an embodiment, the joint term rider has a face value and provides for death benefits in determined amounts upon the death of each of the insureds. The death benefits for the insureds may differ or may be the same. The joint term life rider has associated therewith an accelerated benefit rider or accelerated benefit endorsement. The accelerated benefit rider is not directly connected with the policy, but serves as a rider to the joint term rider. The accelerated benefit rider is applicable to each insured. The accelerated benefit rider provides acceleration of benefits when the joint insured has an accelerated benefit eligible status. The accelerated benefit eligible status may be the status of having a terminal illness, and may include having a certification, provided by one or more medical professionals, of the terminal illness and a maximum estimated life expectancy. The accelerated benefit eligible status may include the status of having a disease or condition that does not meet the conditions for a terminal illness but includes loss of motor or cognitive function. The accelerated benefit eligible status may include the status of having a chronic disease with severe impairment of at least two activities of daily living. The accelerated benefit eligible status may include the status of having a certification by one or more medical professionals of the chronic disease and the severe impairment of at least two activities of daily living (ADLs).

The following list of activities describes several examples of what may be considered as ADLs: 1. Bathing—the ability to wash oneself by sponge, bath or in either a tub or shower, including the task of getting into or out of the tub or shower. 2. Continence—the ability to maintain control of bowel or bladder function, or, when unable to maintain control of bowel or bladder function, the ability to perform associated personal hygiene, including caring for a catheter or colostomy bag. 3. Dressing—the ability to put on and take off all items of clothing and any necessary braces, fasteners or artificial limbs. 4. Eating—the ability to feed oneself by getting food into the body from a receptacle, such as a plate, cup, or table or by feeding tube or intravenously. 5. Toileting—the ability to get to and from the toilet, getting on and off the toilet, and performing associated personal hygiene. 6. Transferring—the ability to move into or out of a bed, chair or wheelchair.

In an embodiment, upon attaining accelerated benefit eligible status, a benefit period may commence. The benefit period may have a predetermined term, such as one year. At the end of the benefit period, if the insured is still living, and the maximum benefit payment amount has not been reached, a renewed certification may be needed of the benefit eligible status of the insured in order for accelerated benefit payments to continue.

If the processor accesses data indicative that one of the joint insureds has an accelerated benefit eligible status 610, the processor accesses 615 from the memory storage device data indicative of an accelerated benefit formula from which an accelerated benefit amount, available under the accelerated benefit rider of the joint term rider to the insured who has the accelerated benefit eligible status, may be determined.

In an embodiment, the benefit amount over the full term of the benefit for insured x may be determined as follows:

LBAABₜₓ=DBₜₓ+BaseTermₜ (1)

LMBAₜₓ=LBAP*LBAABₜₓ (2)

Table 1 below provides the values of the variables in Equations (1) and (2):

TABLE 1

| Variable | Description |
|---|---|
| DBₜₓ | Death Benefit, time t, for insured x |
| | This assumes any adjustments for Minimum |
| | Death Benefit requirement. |
| BaseTermₜₓ | Face Amount of Term Rider on Base Insured x, time t |
| LBAP(x) | Living Benefit Specified Percentage for insured x |
| | This variable may be different for the different |
| | insureds under the last survivor policy |
| LBAABₜ | Living Benefit Acceleration Amount Basis |
| | (Eligible Amount), time t, insured x |
| LMBAₜₓ | Lifetime Benefit Amount, time t, insured x |

In an embodiment, the death benefit amount under the term rider may be set at zero, and the face amount of the term rider is the full death benefit under the term rider. The living benefit specified percentage may be 100% or any lower percentage.

The maximum periodic benefit amount may be a percentage, such as 2%, of the face amount of the term rider on the base insured, or may be based on an allowable per diem rate, such as an IRS per diem rate at the time that the claim for accelerated benefits is submitted, or an IRS per diem rate at the time the policy is issued, with predetermined percentage increases on an annual or other basis. The period of payments may be monthly, quarterly, or another period. An insured may have an option of determining a timing of payments, such as monthly or quarterly.

In an embodiment, an insured may have an option of selecting a periodic benefit amount less than the maximum amount. The insured may have the option of changing the periodic benefit amount after the commencement of payments. In an embodiment, the processor may cause 620 the insured to be prompted to select a benefit amount. The insured may provide instructions for selection of an initial periodic benefit amount or a changed periodic benefit amount employing a system as disclosed in FIG. 2 above. The processor may receive 625 a selected benefit payment amount. The processor may format an output signal having data indicative of a payment amount in accordance with the selected benefit payment amount, payee and payment date, and direct 630 the output signal to a payment determination system.

In an embodiment, an insured may have an option of receiving the accelerated benefit in a lump sum. The following expression may be employed for a lump sum benefit amount for insured x:

LumpSumₓ=DBₜₓ/((1+i)^{Le}) (3)

Where the following table provides the values of the variables:

TABLE 2

| Variable | Description |
|---|---|
| t | Policy Month in which Lump Sum Payment will be made |
| DBₜₓ | Death benefit amount under the term rider applicable to the |
| | insured. |
| i | Interest rate. The rate may be fixed, or may be based on a |
| | reference, such as the Moody's 30 year corporate bond |
| | average at the time of calculation. |
| Le | Life expectancy of the insured based on the attained age of |
| | the insured in policy month t |
| LumpSumₓ | Lump Sum proceeds to be received by the owner |

Thus, the lump sum amount increases as the life expectancy according to actuarial data of the insured decreases, i.e., as the insured ages, the lump sum amount approaches the term rider death benefit amount.

In an embodiment, the available death benefit for an insured under the joint term rider and the acceleration benefit for the insured may be reduced on a dollar for dollar basis for accelerated benefits paid. In an embodiment, either of the available death benefit or the acceleration benefit may be reduced based on a reduction ratio. The reduction ratio may be expressed as Equation (4):

Reduction Ratio=1−(A/B) (4)

### Where:

A is the monthly benefit payment, and
B is the eligible amount immediately prior to a benefit payment. The eligible amount is the amount available for payment of death benefits or accelerated benefits.

Equation (4) and a dollar for dollar reduction of the death benefit amount based on accelerated benefit payments provide the same result. In other embodiments, the reduction ratio may be defined as a formula which provides a different result from a dollar for dollar reduction.

The face amount of the term rider may be reduced if the benefit amount of the last survivor policy is reduced. In an embodiment, the following equation may be employed to calculate the reduction in the face amount of the term rider if the benefit amount of the last survivor policy is reduced:

InsFaceₓₜ=ProRataRatioₜ*InsFace_{x,t-1} (5)

Where InsFaceₓₜ is the face amount of term insurance for insured x after the reduction; InsFace_{x,t-1} is the face amount of term insurance for insured x immediately prior to the reduction, and ProRataRatioₜ is equal to 1−(A/B), where A is the Reduced Base Policy Face Amount, and B is the Base Policy Face Amount Prior to Reduction. Accordingly, the reduction is proportional. In an embodiment, the reduction may be other than proportional to the reduction in the last survivor policy face amount. Referring to FIG. 6A again, in an embodiment, the processor may access 640 data indicative of whether the benefit amount of the last survivor life policy has been reduced. Referring now to FIG. 6B, if the benefit amount has been reduced 645, then the processor may determine 650 the reduced face amounts of the term riders employing Equation (5), for example. The reduced face amounts may be stored by the processor in a memory device.

The processor may access 655 data indicative of whether either or both of the insureds, or fewer than all of the insureds, is deceased. If one of the insureds is deceased 660, the processor accesses data 665 indicative of a death benefit amount under the term rider and indicative of a previously paid accelerated benefit amount. As discussed above, the amount of the previously paid accelerated benefit reduces the death benefit amount under the term rider. The processor determines 670 whether a death benefit is payable and the amount of the death benefit. If a death benefit is payable 675, the processor outputs 680 a signal having data indicative of the death benefit amount. Otherwise, the process flow returns to accessing data as to whether any further insureds are deceased, as indicated by reference D on FIGS. 6B and 6C. If both of the insureds are deceased 685, the processor accesses 690 data indicative of the death benefit amount under the last survivor policy, the death benefit amount under the term rider applicable to the last to die of the insureds, and identities of beneficiaries of each of those death benefits. The death benefit amount under the last survivor policy is independent of any accelerated benefit payments made to any of the insureds under any of the term riders. The processor outputs 695 a signal having data indicative of the amount of the death benefit under the last survivor policy, the amount of the death benefit under the joint term rider, and the identities of the respective beneficiaries. If none of the insureds are deceased, the process flow returns to accessing data indicative of whether any of the insureds are deceased, as indicated by reference E on FIGS. 6B and 6C.

In an embodiment, the processor may be adapted to determine whether the joint term rider has been canceled for nonpayment of premium. For example, the processor may access data indicative of the current status of the policy and one or more riders. In an embodiment, the policy may have a single premium, and so would not be subject to cancellation for nonpayment once the single premium is paid, while the joint term rider may have a periodically payable premium. If the data is indicative that the joint term rider has been canceled for nonpayment of premium or for another reason, then the processor would not determine a death benefit to be paid so long as at least one of the insured is still living.

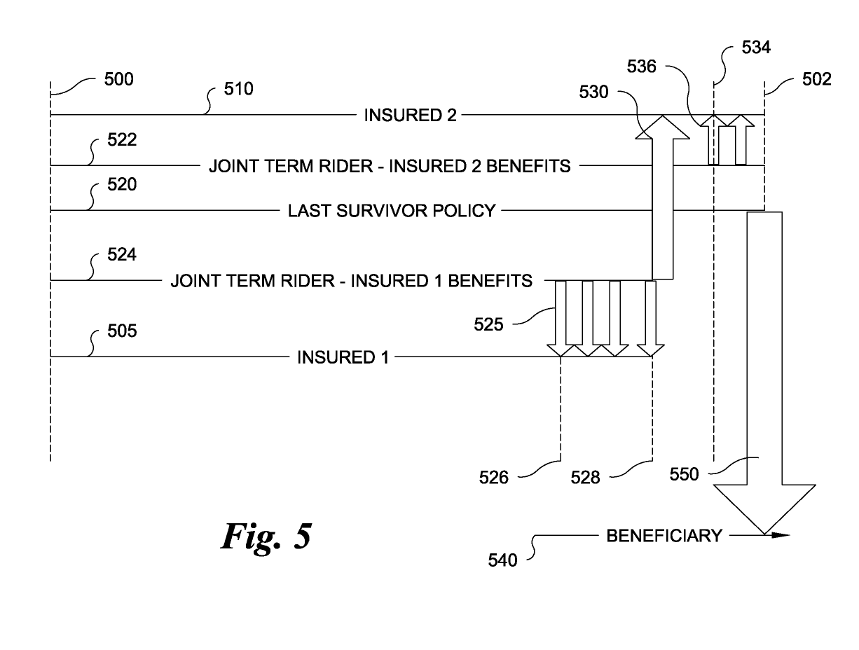

Referring to FIG. 5, a schematic diagram is provided showing features of a last survivor policy in an embodiment. In FIG. 5, time is shown from the time 500 of issue of the last survivor policy 520 with a joint term rider until time 502 of the last to die of the joint insureds. In this embodiment, there are two joint insureds: insured 1 505 and insured 2 510. The joint term rider has separate benefits 522, 524 for insured 1 and insured 2. Insured 1 505 becomes eligible for accelerated benefits, such as by providing a certification by a medical professional of a terminal illness or a chronic illness involving sufficient loss of activities of daily living, and receives accelerated benefit payments 525 from a time of eligibility 526 until time of death 528 of insured 1. Upon the death of insured 1, a death benefit 530 under the benefits 524 of the joint term rider, which may be the face amount death benefit less the amount of accelerated benefit payments 525, is paid to the beneficiary, who in this embodiment is insured 2 510.

Thereafter, insured 2 510 becomes eligible for accelerated benefits at time 534, such as by providing a certification by a medical professional of a terminal illness or a chronic illness involving sufficient loss of activities of daily living. Insured 2510 receives accelerated benefit payments 536 until a time 502 of the death of insured 2 510. Upon the death of insured 2 510, a death benefit 550 under the last survivor policy is paid to beneficiary 540. Beneficiary 540 may be an estate of the last to die of the insured, for example, and the death benefit from the last survivor policy may be used to provide liquidity for payment of estate taxes. Beneficiary 540 may be a closely-held corporation, and the death benefit from the last survivor policy may be used to provide liquidity to fund a buy back of stock from a deceased owner.

In embodiments, calculations of certain charges associated with policies and riders may be determined by a computer system and stored in memory devices, output to displays and printers, and/or included in other output signal data. Calculation of current unit cost of insurance (cost for a specified benefit, such as $1000) for the joint term rider in a month j of the policy (CCOIⱼ), the current joint term charges in a month j of the policy (JTRCⱼ) and guaranteed unit charges for cost of insurance in a month j of the policy (GCOIⱼ) and guaranteed joint term charges in a month j of the policy (JTGRCⱼ) may be determined by a computer system employing the following formulas:

### Current Unit Charge:

CCOIⱼ=MIN[Cq_{z+t-1},1.0]/12 (6)

JTRCⱼ=CCOIⱼ*(TermChgBasisₓ+TermChgBasis_{y})/1000 (7)

### Guaranteed Unit Charge:

GCOIⱼ=MIN[Gq_{z+t-1},1.0]/12 (8)

JTGRCⱼ=GCOIⱼ*(TermChgBasisₓ+TermChgBasis_{y})/1000, (9)

The values of the variables in equations (6)-(9) may be determined by a computer system employing the following formulas.

$$\begin{matrix}{Cq}_{z + t - 1} = \frac{\begin{matrix}{TermChgBasisFactor}_{x} * ( {}_{t - 1}^{}{Cp}{}_{x}^{} - {}_{t}^{}{Cp}{}_{x}^{} ) + \\ {TermChgBasisFactor}_{y} * ( {}_{t - 1}^{}{Cp}{}_{y}^{} - {}_{t}^{}{Cp}{}_{y}^{} )\end{matrix}}{{}_{t}^{}{Cp}{}_{z}^{}} & ( 10 ) \\ {Gq}_{z + t - 1} = \frac{\begin{matrix}{TermChgBasisFactor}_{X} * ( {}_{t - 1}^{}{Gp}{}_{x}^{} - {}_{t}^{}{Gp}{}_{x}^{} ) + \\ {TermChgBasisFactor}_{y} * ( {}_{t - 1}^{}{Gp}{}_{y}^{} - {}_{t}^{}{Gp}{}_{y}^{} )\end{matrix}}{{}_{t}^{}{Gp}{}_{z}^{}} & ( 11 )\end{matrix}$$

### Where:

TermChgBasisFactorₓ=TermChgBasisₓ/(TermChgBasisₓ+TermChgBasis_{y}) (12)

TermChgBasisFactor_{y}=TermChgBasis_{y}/(TermChgBasisₓ+TermChgBasis_{y}) (13)

In these formulas, the subscript x refers to an issue age and gender of a first one of the insureds, and the subscript y refers to an issue age and gender of a second one of the insureds. The subscript z refers to issue ages and genders of two insureds, and may represent the probability that both insureds will be living at a particular time. The values of further variables are set forth in the following table:

TABLE 3

| Variable Name | Description |
|---|---|
| j | Policy month |
| Cqₓ₊ₜ₋₁ | Current term rider mortality rate for the first insured, policy year t. |
| Cq_{y+t-1} | Current term rider mortality rate for the second insured, policy year t. |
| Flatextra_{x,t} | Flat extra rating (i.e., additional charge) per dollar of insurance |
| | for the first insured, policy year t. |
| Flatextra_{y,t} | Flat extra rating per dollar of insurance for the second insured, |
| | policy year t. |
| Gqₓ₊ₜ₋₁ | Maximum mortality rate for the first insured, policy year t. |
| Gq_{y+t-1} | Maximum mortality rate for the second insured, policy year t. |
| Tablerate_{x,t} | Table rating for first insured, policy year t, obtained |
| | from a table of standard mortality charges, and |
| | modified by a multiplier provided as a result of the |
| | underwriting process |
| Tablerate_{y,t} | Table rating for second insured, policy year t., |
| | obtained from a table of standard mortality charges, |
| | and modified by a multiplier provided as a result of the |
| | underwriting process |
| TermChgBasisₓ | Term Insurance Charge Basis on first insured |
| | This is equal to the initial term face value on the first |
| | insured, or current Term face value if adjusted for |
| | automatic reduction. This value is not reduced by any |
| | benefits taken or claims paid. |
| TermChgBasis_{y} | Term Insurance Charge Basis on second insured |
| | This is equal to the initial term face value on second |
| | insured, or current Term face if adjusted for automatic |
| | reduction. This value is not reduced by any benefits |
| | taken or claims paid. |
| TermChgBasisFactorₓ | Weighting for Term coverage on first insured |
| TermChgBasisFactor_{y} | Weighting for Term coverage on second insured |
| JTRCⱼ | Current Joint Term Insurance Rider Charge, month j |
| JTGRCⱼ | Guaranteed Joint Term Insurance Rider Charge, month j |

Further intermediate formulas are as follows:

Cqₓ₊ₜ₋₁=min[(Cqₓ₊ₜ₋₁×Tablerate_{x,t}+Flatextra_{x,t}), 1.0] (14)

Cq_{y+t-1}=min[(Cq_{Y+t-1}×Tablerate_{y,t}+Flatextra_{y,t}), 1.0] (15)

Gqₓ₊ₜ₋₁=min[(Gqₓ₊ₜ₋₁×Tablerate_{x,t}+Flatextra_{x,t}), 1.0] (16)

Gq_{y+t-1}=min[(Gq_{Y+t-1}×Tablerate_{y,t}+Flatextra_{y,t}), 1.0] (17)

The above values reflect the fact that each insured must be insurable for the term rider. In the prior art, joint term policies are issued where only one of two joint insureds is independently insurable.

₀Cpₓ=₀Cp_{y}=₀Cp_{z}=₀Gpₓ=₀Gp_{Y}=₀Gp_{z}=1 (18)

The immediately above formula reflects that the probability that the insureds are alive at policy issue is 1. The subscript z used in this formula and others reflects joint probabilities.

ₜCpₓ=(1−Cqₓ₊ₜ₋₁)×ₜ₋₁CPₓ (19)

ₜCp_{Y}=(1−Cq_{y+t-1})×ₜ₋₁Cp_{Y} (20)

ₜGpₓ=(1−Gqₓ₊ₜ₋₁)×ₜ₋₁Gpₓ (21)

ₜGp_{Y}=(1−Gq_{y+t-1})×ₜ₋₁Gp_{Y} (22)

ₜCp_{z}=ₜCpₓ+ₜCP_{y}−(ₜCpₓ×ₜCp_{y}) (23)

ₜGp_{z}=ₜGpₓ+ₜGp_{y}−(ₜGpₓ×ₜGp_{y}) (24)

The immediately above formulas reflect probabilities of the first insured, for variables with the subscript x, the second insured, for subscript y, or either or both of the insureds, for subscript z, being alive at times t following policy issue. The foregoing formulas are appropriate for calculation of premiums in which pricing for the last survivor policy is based on all of the lives of the insureds. The calculation of premiums on this basis is known in the art as Frasierization. In calculation of premiums using Frasierization, the premium for the last survivor policy is not altered during the term of the policy as a result of the death of one of the insureds. Frasierization is a known actuarial method to calculate the probability of the second death on last survivor policies using single life mortality tables. Such calculations determine a cost of insurance rate to reflect the appropriate mortality risk for a last survivor policy using the industry standard mortality tables for each of the insureds as single lives based on age and gender, as well as risk class determined through underwriting.

Suitable exemplary calculation details for the accelerated benefit rider charges follow. The rider charge for the accelerated benefit rider is based on the product A*B*C, where:

A=policy cost of insurance (COI) rate

B=policy accelerated benefit factor,

C=benefit size discount factor, and

In an embodiment, the variables A, B and C may be further defined as follows:

A is based on the charge for the Joint Term Rider as in Equations (7) and (9) above.

B is the Accelerated Benefit Rider Factor, which is set at issue in an embodiment. This factor will vary by gender and issue age for variable universal life policies, and by gender, issue age, and risk class for universal life policies. This is a morbidity factor to account for the risk of illness or disability and is based on actuarial pricing assumptions. The determination of morbidity factors is well known in the determination of health-based risks in the life insurance field. This factor is required for each insured. This factor is the weighted average of the corresponding factors for each insured.

C is a benefit size discount factor.

Variables for factors that enter into the calculation of B above are set forth in the following Table 3.

TABLE 3

| Variable | Description |
|---|---|
| j | Policy Month |
| Cⱼ | Benefit size discount factor |
| COIⱼ | Cost of insurance for Joint Term Rider with accelerated |
| | benefit; this COI variable will use the Joint Term Rider |
| | frasierized COIs. |
| LBAP | Accelerated benefit Specified Percentage. In some |
| | embodiments, this percentage may be 100%. |
| LTCFactor | Accelerated Benefit Rider Factor. |
| | The value of this factor is derived from a standard mortality |
| | table. In an embodiment, the value will be based on the |
| | ages and genders of the insureds at issue, and will not |
| | change over the life of the policy. A table factor will be |
| | used for both Insured x and Insured y to determine the |
| | weighted average of the two factors. |
| LTCRateⱼ | Accelerated Benefit Rider Rate |
| | This rate will be calculated - see below |
| LTCChargeⱼ | Total Charge for Accelerated Benefit Rider, time t, |
| | segment n |

The formula for the accelerated benefit rider factor is expressed as follows when used with the Joint Term Rider:

$${LTCFactor}_{z} = \frac{\begin{matrix}( {LTCFactor}_{x} * {TermChgBasis}_{x} ) + \\ ( {LTCFactor}_{y} * {TermChgBasis}_{y} )\end{matrix}}{{TermChgBasis}_{x} + {TermChgBasis}_{y}} , \qquad ( 25 )$$

In a non-limiting example, in a policy with two insureds, with a first insured having a term rider with a face value of $400,000, and a second insured having a term rider with a face value of $600,000, the calculation of the rider amounts may be as follows:

TermChgBasisₓ=400,000

TermChgBasis_{y}=600,000

LTCFactorₓ=0.131432

LTCFactor_{y}=0.212973
The values of LTCFactorₓ and LTCFactor_{y} are derived from standard mortality tables with adjustments by factors to reflect underwriting.

LTCFactor_{z}=[(0.131432*400,000)+(0.212973*600,000)]/(400,000+600,000)=(52573+127784)/1000000=0.180357 (the weighted LTCFactor)

LTCRateⱼ=LTCFactor_{z}*JTRCⱼ (26)

where,

JTRCⱼ=Joint Term Rider charge for both insureds, as a single charge As indicated by the formulas above, LTCFactor_{z} is a weighted average accelerated benefit rider factor based on table factors for each insured individually. Thus, the charge for the rider for the accelerated benefits may be determined as a fraction of the joint term rider charge, based on weighting, in accordance with the respective term rider face amounts and factors obtained from actuarial tables.

It will be appreciated that the charge for the joint term rider and the acceleration benefit are blended rates, taking into account the mortality charges associated with each of the insureds. Similar blended rate calculations may be performed with respect to reserves associated with the last survivor life insurance policy, demonstration of compliance with nonforfeiture requirements; determination of shadow fund values; determination of premium limitations associated with life insurance status for certain regulatory purposes; and determination of fair market values of life insurance policies for various purposes such as deemed compensation in split-dollar funded life insurance programs.

The administration of shadow accounts associated with the last survivor policy will now be explained. Shadow accounts typically are maintained to determine whether a death benefit is payable; positive values in shadow accounts are generally not available for the insured or other client for withdrawal, borrowing or otherwise. In an embodiment, rider charges affect shadow account value. Accelerated benefit payments do not affect shadow account value.

While examples of calculations have been provided for two insureds, in an embodiment, three or more insureds may be provided for in the last survivor policy, and each insured may have a term rider and an accelerated benefit rider or endorsement on the term rider. Those of skill in the art will be able to adapt the exemplary formulas above to three or more insureds. Three or more insureds may be desirable, in a non-limiting example, in the case of a closely held business having three or more owners.

In an embodiment, a benefit on a joint term rider of a last survivor policy for a group of employees of a small employer may be a cost of living increase (COLI). A level charge may be determined for that benefit.

Embodiments of the present invention are operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in each method described herein. Each means may be implemented by processor 110 executing instructions contained in programs which may be stored in a storage medium, such as memory device 120 or data storage 131. The instructions may, when executed by a processor, cause the processor to execute algorithms disclosed in association with each step. It will be appreciated that any of the steps in the methods in accordance with the invention described herein may be so implemented.

An exemplary advantage of a system and method in accordance with an embodiment is that pricing for riders and other features of last survivor policies may be properly determined at time of issue. For example, the cost of coverage to provide a death benefit on the deaths of each of the insureds under the last survivor policy is predictable at issue, with no variation on the death of the first insured. With respect to last survivor policies, joint term life riders may provide death benefits on the death of the first-to-die of the insureds.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for administering a last survivor life insurance policy paying a death benefit on the last to die of a first insured and a second insured, comprising:
a processor;
a memory storage device in communication with the processor;
the processor adapted to:
store data indicative of at least the insureds and the death benefit under the last survivor life insurance policy;
store data indicative of joint term life riders associated with the policy and providing death benefits upon the death of either of the insureds;
store data indicative of living benefit riders associated with the joint term life riders and permitting acceleration of the death benefits;
store data indicative of a premium for the joint term life riders, the premium being level from issue of the policy until the death of the last survivor of the insureds;
access data indicative of whether either of the insureds has a terminally ill status;
responsive to accessing data indicative that one of the insureds has a terminally ill status, prompt a user for a periodic payment amount under the living benefit rider;
receive from the user the periodic payment amount;
output a signal having data indicative of instructions to pay the one of the insureds benefits in accordance with the received periodic payment amount;
access data indicative of whether either or both of the insureds is deceased;
responsive to accessing data indicative that one of the insureds is deceased, access data indicative of a death benefit amount payable under the joint term life riders;
output a signal having data indicative of the death benefit amount;
responsive to accessing data indicative that both of the insureds are deceased, access data indicative of the death benefit amount under the last survivor policy and an identity of a beneficiary, the identity including at least a name and address; and
output a signal having data indicative of the amount of the death benefit under the last survivor policy and the identity of the beneficiary.

2. The system of claim 1, wherein the amount of the death benefit under the last survivor policy is determined independent of any death benefit amount paid under the joint term rider.

3. The system of claim 1, wherein the processor is further adapted to, upon receipt of a signal indicative of a reduction in the benefit amount of the last survivor policy, determining proportional reductions in the benefit amounts associated with the joint term rider, and provide an output signal indicative of the reduced benefit amounts of the joint term rider.

4. A computer system for administering a last survivor life insurance policy paying a death benefit on the death of the last survivor of a plurality of insureds, comprising:
a processor; and
a memory storage device in communication with the processor;
the processor adapted to:
determine at least one variable of a feature related to the policy based on a mortality charge based on, for each future year of the policy, a sum of the statistical likelihoods of the deaths of each of the insureds determined as of the policy issue date;
store data indicative of the determined variable;
output a signal having data indicative of the determined variable;
access data indicative of whether any of the insureds is deceased;
responsive to accessing data indicative that all of the insureds are deceased, access data indicative of the death benefit amount under the policy and an identity of a beneficiary, the identity including at least a name and address; and
output a signal having data indicative of the amount of the death benefit under policy and the identity of the beneficiary.

5. The computer system of claim 4, wherein the feature is a joint term life rider paying a death benefit on the death of each of the insureds, and the variable is a premium for the joint term life riders, the premium being fixed in amount at issue of the policy and independent of the death of the first to die of the insureds; and wherein the processor is further adapted to:
after accessing data indicative of whether one or more of the insureds is deceased, if at least one but fewer than all of the insureds is deceased, access data as to each of the deceased insureds indicative of a death benefit amount under the joint term rider; and
responsive to accessing data indicative that a death benefit is payable, output a signal having data indicative of the death benefit amount.

6. The computer system of claim 5, wherein the premium for the joint term life riders is a single premium.

7. The computer system of claim 6, wherein the premium for the policy is a single premium.

8. The computer system of claim 5, wherein the premium for the joint term life riders is payable periodically from issue of the policy until the death of the last to die of the insureds, and the processor is further adapted to determine whether the joint term rider has been canceled for nonpayment of premium.

9. The computer system of claim 5, wherein the processor is further adapted to:
access data indicative of whether any of the insureds has an accelerated benefit eligible status under an acceleration rider of the joint term rider;
responsive to accessing data indicative that one of the insureds has an accelerated benefit eligible status, access data indicative of an accelerated benefit formula under the acceleration rider; and
output a signal having data indicative of instructions to pay a corresponding owner of the joint term life rider in accordance with the accelerated benefit formula.

10. The computer system of claim 9, wherein the corresponding owner is the insured having the accelerated benefit eligible status.

11. The computer system of claim 9, wherein the accelerated benefit eligible status is the status of having a terminal illness with less than a specified life expectancy.

12. The computer system of claim 9, wherein the accelerated benefit eligible status is the status of having a chronic disease with severe impairment of at least two activities of daily living.

13. The computer system of claim 9, wherein a maximum of payments in accordance with the accelerated benefit formula for each of the insureds is not greater than the death benefit amount for each of the insureds under the joint term rider.

14. The computer system of claim 5, wherein the processor is further adapted to access data indicative of a reduction in the benefit amount under the last survivor policy, and determine a reduction in the benefit amount under the joint term rider proportional to the reduction of the benefit amount under the policy.

15. The computer system of claim 5, wherein the benefit amounts under the joint term rider are determined at the time of issue of the last survivor policy.

16. The computer system of claim 4, further comprising:
a payment determination system having a payment determination system processor and a payment determination system memory in communication with the payment determination system processor, the payment determination system processor being adapted to receive one of the output signals, determine a payor account and a payment method; store the determined payor account information and the determined payment method in the payment determination system memory; outputting of a digital signal having data indicative of the stored payor account information, the stored payment method, amount information and payee information; and
a payment fulfillment system for receiving the digital signal from the payment determination system and for fulfillment of payment in accordance with the data conveyed by the digital signal from the payment determination system processor.

17. The computer system of claim 16, wherein the payment fulfillment system is a check printing and mailing system for printing and mailing a check drawn on the payor account in an amount and to a payee as determined by the information conveyed by the digital signal from the processor of the payment determination system.

18. The computer system of claim 16, wherein the payment fulfillment system is a system for generating electronic funds transfer instructions for providing of an instruction to a bank determined by the payor account information to provide an electronic funds transfer from the payor account to a payee account in an amount determined by the information conveyed by the digital signal from the processor of the payment determination system.

19. A computer-implemented method for administering a last survivor life insurance policy paying a death benefit on the death of the last survivor of a plurality of insureds, comprising:
determining by the processor at least one variable of a feature related to the policy based on a mortality charge based on, for each future year of the policy, a sum of the statistical likelihoods of the deaths of each of the insureds determined as of the policy issue date;
storing by the processor in a memory device data indicative of the determined variable;
outputting by the processor a signal having data indicative of the determined variable;
accessing by the processor data indicative of whether the insureds are deceased;
responsive to accessing data indicative that all of the insureds are deceased, accessing by the processor data indicative of the death benefit amount under the policy and an identity of a beneficiary, the identity including at least a name and address; and
outputting by the processor a signal having data indicative of the amount of the death benefit under the policy and the identity of the beneficiary.

20. The computer-implemented method of claim 19, wherein the feature is a joint term life rider paying a death benefit on the death of each of the insureds, and the variable is a premium for the joint term life riders, the premium amount being fixed at issue of the policy and independent of the death of the first to die of the insureds; and further comprising the steps of:
after accessing by the processor data indicative of whether one or more of the insureds is deceased, responsive to accessing data indicative that at least one but fewer than all of the insureds is deceased, accessing by the processor data as to each of the deceased insureds indicative of a death benefit amount under the joint term rider; and
responsive to accessing data indicative that a death benefit is payable, outputting by the processor a signal having data indicative of the death benefit amount.

21. The computer-implemented method of claim 20, wherein the premium for the joint term life riders is a single premium.

22. The computer-implemented method of claim 20, wherein the premium for the joint term life riders is payable periodically from issue of the policy until the death of the last to die of the insureds, and the processor is further adapted to determine whether the joint term rider has been canceled for nonpayment of premium.

23. The computer-implemented method of claim 20, further comprising the steps of:
accessing by the processor from a memory storage device data indicative of whether any the insureds has an accelerated benefit eligible status under an acceleration rider of the joint term rider;
responsive to accessing data indicative that one of the insureds has an accelerated benefit eligible status, accessing by the processor from the memory storage device data indicative of an accelerated benefit formula for one or more accelerated benefit payments under the acceleration rider;
outputting by the processor a signal having data indicative of instructions to pay the one of the insureds in accordance with the accelerated benefit formula.

24. The computer-implemented method of claim 23, wherein a maximum of payments in accordance with the accelerated benefit formula for one of the insureds is not greater than the death benefit amount for the one of the insureds under the joint term rider.

25. The computer-implemented method of claim 23, further comprising accessing data indicative of a reduction in the benefit amount under the last survivor policy, and determining a reduction in the benefit amount under the joint term rider proportional to the reduction of the benefit amount under the last survivor policy.

26. The computer-implemented method of claim 23, wherein the benefit amounts under the joint term rider differ for each insured.

27. A computer-readable medium having a plurality of instructions thereon for use in administration of last survivor life insurance policies having a death benefit payable upon the death of the last to die of at least two insureds, which instructions, when executed by a processor, cause the processor to:
determine at least one variable of a feature related to the policy based on a mortality charge based on, for each future year of the policy, a sum of the statistical likelihoods of the deaths of each of the insureds determined as of the policy issue date;
store data indicative of the determined variable;
output a signal having data indicative of the determined variable;
access data indicative of whether any of the insureds is deceased;
responsive to accessing data indicative that all of the insureds are deceased, access data indicative of the death benefit amount under the policy and an identity of a beneficiary, the identity including at least a name and address; and
output a signal having data indicative of the amount of the death benefit under policy and the identity of the beneficiary.

28. The computer-readable medium of claim 27, wherein the feature is a joint term life rider paying a death benefit on the death of each of the insureds, and the variable is a premium for the joint term life riders, the premium amount being fixed at issue of the policy and independent of the death of the first to die of the insureds; and wherein the instructions, when executed by a processor, further cause the processor to:
after accessing data indicative of whether one or more of the insureds is deceased, if at least one but fewer than all of the insureds is deceased, access data as to each of the deceased insureds indicative of a death benefit amount under the joint term rider; and
responsive to accessing data indicative that a death benefit is payable, output a signal having data indicative of the death benefit amount.

29. The computer-readable medium of claim 27, wherein the instructions, when executed by the processor, further cause the processor to determine a reduced death benefit payable under the term rider based on the payments in accordance with the accelerated benefit formula and a reduction factor.
